(19) United States
(12) Patent Application Publication
(10) Pub. No.: US 2013/0186124 A1
(43) Pub. Date: Jul. 25, 2013

(54) Refrigerated Food Management System

(71) Applicants: Stanley E. Wiklinski, Old Tappan, NJ (US); Alfonse J. Carratura, Westwood, NJ (US)

(72) Inventors: Stanley E. Wiklinski, Old Tappan, NJ (US); Alfonse J. Carratura, Westwood, NJ (US)

(21) Appl. No.: 13/358,224

(22) Filed: Jan. 25, 2012

(51) Int. Cl. F25D 25/02; F25D 27/00

(52) U.S. Cl. 62/264; 62/465

(57) ABSTRACT

A computerized refrigerator/freezer system uses rotating carousels and assigns specific storage locations based on bar code readings or user input. Retrieval and replacement of food items is facilitated by computer-controlled rotation of the carousels to provide convenient access from the front of the refrigerator or freezer. A transparent “door-within-a-door” in the front of the refrigerator allows convenient and energy-conserving access to food items without opening the larger main access door. The system computer performs inventory tracking and control and can perform optional re-stocking through an internet connection.

### BACKGROUND OF THE INVENTION

The present invention relates to the field of systems and equipment for storing and preserving perishable food items, and more particularly to the field of refrigerated food management, storage and retrieval systems.

We live in the Information Age, so named because we can readily store and access data to manage virtually all aspects of our lives, whether it be related to finances, health, education, recreation, or whatever. In one area that touches our lives and well-being perhaps more directly and intimately than any other, however, we remain as uninformed and unorganized as were our grandparents. When it comes to “our daily bread”—the food that we put on our table each day—we tend to manage it haphazardly, if at all.

Nothing epitomizes this syndrome of neglect better than the typical household refrigerator. Although a family depends critically on its contents to keep themselves well-nourished, food items are often inserted and withdrawn helter-skelter, so that no one is ever sure where some food articles are, how much is left, and how long they've been in there. Food spoilage due to this random approach is estimated to cost each American family an average of five hundred dollars on an annual basis. While we would never dream of making deposits and withdrawals from our bank accounts without recording and tracking them, this is precisely what we do with the food items in our refrigerators.

The primary reason that inventory control of household refrigerated foods is so lax is that existing refrigerator designs make such control terribly inconvenient and time-consuming. While there are fairly sophisticated inventory methods in the food distribution chain up to and including the retail level, with bar codes, expiration dating and computerized tracking, this ends once the food clears the checkout counter and is bagged for the trip home. The setup of the typical refrigerator, with its static horizontal shelves and drawers, almost pre-ordains a “last-in, first-out” pattern of food usage, with older items getting pushed to the back of the shelf or drawer as new items are inserted. The standard refrigerator configuration also discourages any systematic approach to locating specific food items. Even if items are initially placed in the refrigerator in some ordered pattern, that pattern is quickly disrupted by the need to move items in the front out of the way in order to access those in the back.

Haphazard refrigerated food management becomes an even greater problem as the size of refrigerators increases. As shelf and draw space becomes wider and deeper, the potential for items to get “buried”, escape notice and go missing for extended periods of time becomes ever more problematic. Keeping track of the food items that need to be replenished or replaced also becomes progressively more difficult as the size and capacity of refrigeration units expand. Moreover, the standard shelf/drawer setup of refrigerators contributes nothing to making the task of shopping for food any easier. Indeed, it almost compels the hit-or-miss process which goes into compiling a “grocery list”. As a result, families typically have to visit the supermarket several times a week, because the grocery list for each trip is seldom complete and comprehensive.

The irony of this sad situation is that the technology to address it already exists and is waiting to be deployed. On the information side of the problem, the vast majority of food items nowadays come in packaging which is bar-coded with information as to the contents, packaging date and expiration date. The idea of equipping a refrigerator with a bar-code reader is not a new one, but effective food inventory management requires much more than simply reading the bar codes of items placed in the refrigerator.

### SUMMARY OF THE INVENTION

In the computerized food management system of the present invention, the refrigerator re-stocking process involves not only identification of food items but also assignment of a specific storage location for each item within the refrigerator. After scanning of the bar code, or manual identification for bulk items, the system will assign the item a dedicated location and enter its identity and location in the inventory list, along with the date that it was first stored in the refrigerator. Packaging and/or expiration dates would also be entered in the inventory if available.

Since the static horizontal shelf configuration of conventional refrigerators is incompatible with the assignment of fixed locations for food items, the present invention utilizes rotating carousels, so that items can be accessed without moving other items in front of or above them. In place of the horizontal shelf, the present invention uses a turntable-type carousel, which revolves around a vertical axis, much like a “lazy Susan” tray. Each of the carousels is divided into segments so that specific locations can be assigned to food items by alpha-numerical designations, such as “Carousel #2, Segment D”.

In addition to rotating carousels, this refrigerator will also have contoured complementary horizontal shelving in the corners of the storage space around the carousels in order to avoid wasting that area. This shelf storage would also be identified alpha-numerically, such as “Shelf #3.”

The refrigerator is equipped with a computer which compiles information on the stored food items. Once stocking of the refrigerator is completed, the food inventory list can be accessed from a computer screen attached to the refrigerator. Optionally, the screen can be a touch-screen, such that touching the desired inventory entry will activate a retrieval operation, which would spin the appropriate carousel around to a position where the desired item would be accessible from the front of the refrigerator. Alternately, the screen could be equipped with a “mouse” pad or keypad to click on the inventory entry for the desired item or key in its alpha-numeric location in order to activate the retrieval operation.

When a retrieved food item is replaced, the appropriate inventory item on the computer screen is again touched or clicked to activate a replacement operation, which again spins the appropriate carousel into alignment with the front of the refrigerator. If a retrieved item is not replaced within a certain time—an hour, for example—the computer will delete the item from the inventory and add it to a “re-stock” list. The “re-stock” list becomes the basis for future grocery shopping lists. Optionally, the system computer can be wirelessly networked to a remote printer to enable printouts of the inventory and/or re-stock lists, or the computer can be provided with internet access and programmed to periodically upload one or both of these lists to a website affording password-controlled access from a pc or mobile device. With internet access, the programming of the system computer could also offer the option of periodic automated ordering of re-stock items from an online grocery service.

The food management system would also monitor the duration of storage for each item and include that information on its inventory page. Where expiration dates are included in scanned bar codes, the system would be programmed to identify items approaching or past their expiration dates and present appropriate warnings on the computer screen. Where expiration date information is not included in the scanned bar codes, the system programming would contain default expiration periods based on the type of food product.

The refrigerator would have two or more temperature zones, and the system programming would assign storage locations based on the optimal temperature range for each food item. A minimum of two temperature zones, for frozen and non-frozen items, would be provided. Optimally, three or more temperature zones would be provided. The system programming would also assign food item locations based on storage compatibility of different food items, to avoid mixing items that might contaminate or hasten the spoilage of other items.

Another optional feature of the present invention is a “door-within-a-door” with which the rotating carousels would align during the retrieval and replacement operations. The “door-within-a-door,” or central access door, is a transparent panel hingeably inserted in the center of the front refrigerator door. Items to be retrieved from the refrigerator are rotated on the carousels into alignment with the central access door, which can then be opened, allowing the item to be removed without opening the refrigerator's main door. This feature would enhance energy efficiency by enabling items to be removed and replaced without opening the main door(s) of the refrigerator. The “door-within-a-door” would also be helpful for young, elderly and handicapped persons, for whom opening a large refrigerator door may be cumbersome and difficult.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a front elevation view of the first preferred embodiment of the present invention.

FIG. 2 is a perspective detail view of one of the pull-out side panels of the preferred embodiment of the present invention.

FIG. 3 is a cutaway top plan view of a carousel and the door of the preferred embodiment of the present invention.

FIG. 4 is a perspective detail view of the rotating carousels of the preferred embodiment of the present invention.

FIG. 5 is a cutaway perspective view of the rotating carousels and drive assembly of the preferred embodiment of the present invention.

FIG. 6 is perspective detail view of a food bin insertion slot for a carousel of the preferred embodiment of the present invention.

FIG. 7 is a perspective detail view of an insertable food bin for a carousel of the preferred embodiment of the present invention.

### DETAILED DESCRIPTION OF THE PREFERRED EMBODIMENT

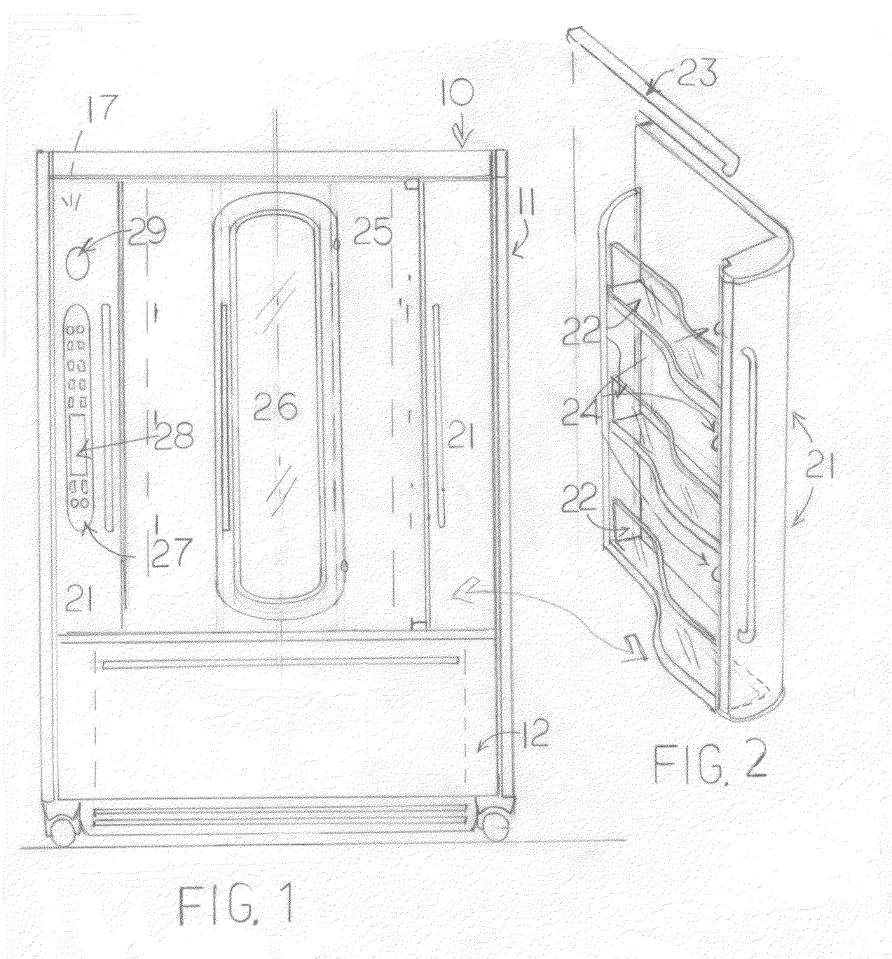

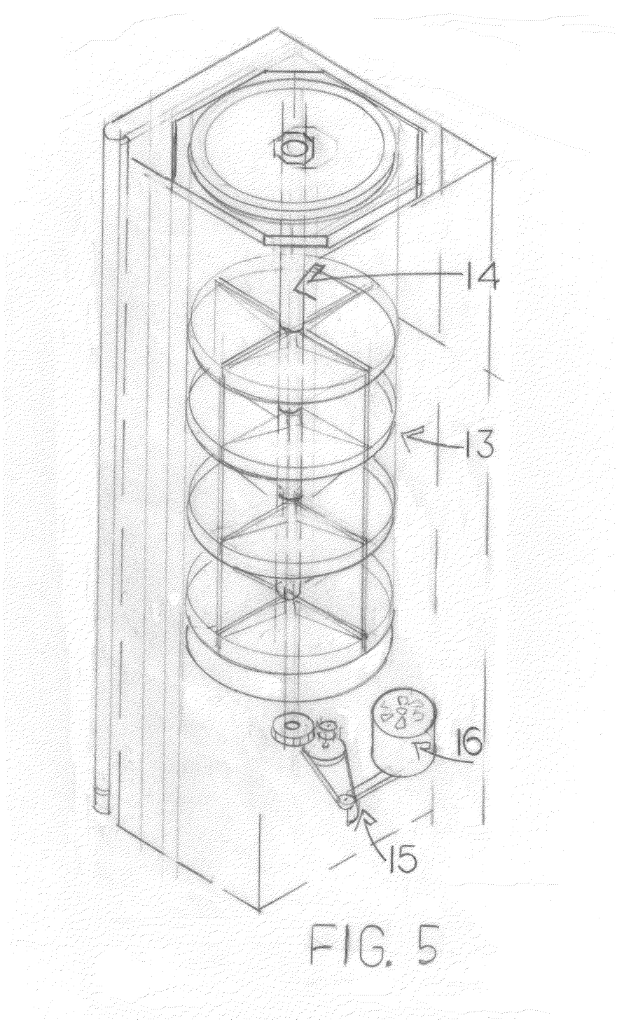

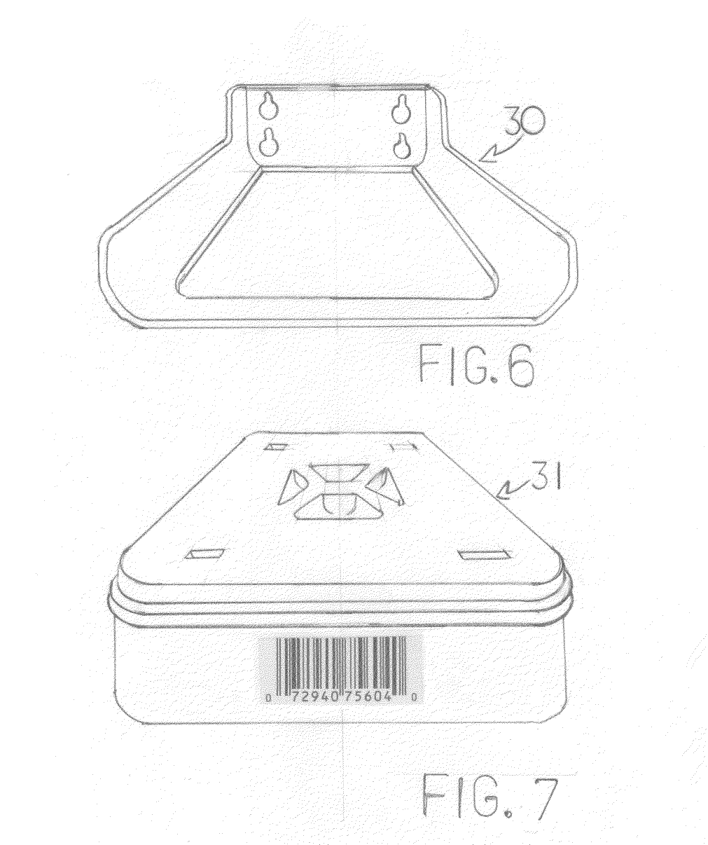

The preferred embodiment of the present invention 10, depicted in FIGS. 1-7, comprises a stacked refrigerator 11 and freezer 12. The refrigerator 11 contains multiple circular carousel shelves 13, which are axially rotatable about one or more vertical spindle(s) 14 by a drive assembly 15 driven by a motor 16 controlled by a system computer 17. Each of the carousel shelves 13 is divided into multiple shelf segments 18, which are demarcated by segment markers 19 containing LED marker lights 20. On either side of the refrigerator 11 surrounding the carousel shelves 13 are two pull-out side panels 21. The side panels 21 contain multiple horizontal side shelves 22, which are contoured to fit around the circular carousel shelves 13, as shown in FIG. 2. The side panels 21 slide in and out of the refrigerator 11 on lateral tracks 23. The side shelves 22 are demarcated by LED shelf lights 24. The interior of the refrigerator 11 is accessed through a main access door 25, within which is hingeably inserted a transparent central access door 26. The central access door 26 can be opened independently of the main access door 25, so that food items centrally positioned on the carousel shelves 13 can be readily viewed and removed. Temperatures within the refrigerator 11 are controlled by one or more refrigerator thermostats. Temperatures within the freezer 12 are controlled by one or more freezer thermostats.

The system computer 17 has a keypad 27 and a display screen 28 recessed in the front or side of the refrigerator 11. The computer 17 interfaces with the drive assembly 15 and motor 16 and with the refrigerator and freezer thermostats. The computer 17 also interfaces, again preferably wirelessly, with one or more bar code scanner(s) 29.

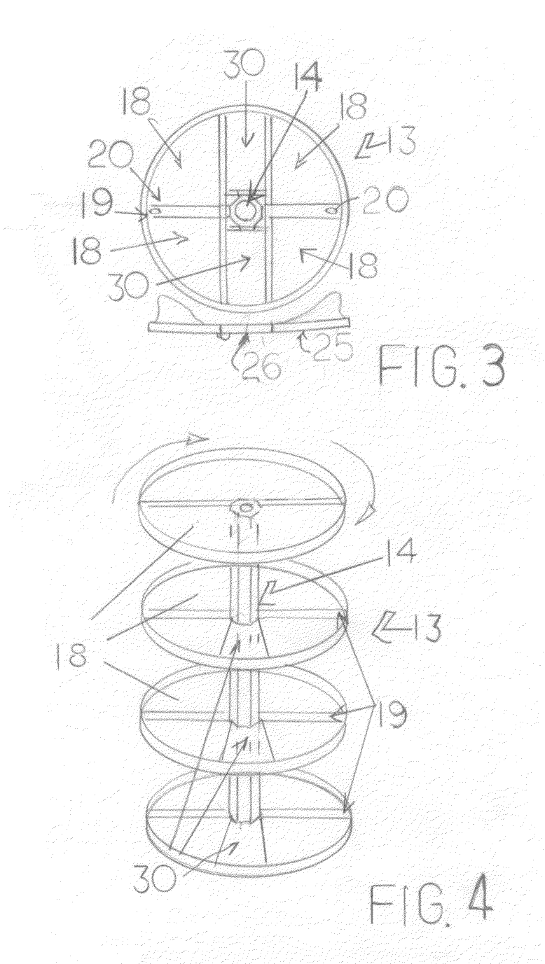

As shown in FIGS. 3 and 6, one or more of the carousel shelves 13 can have an insertion slot 30 into which a food bin 31 can be removably snapped into place. The food bins 31 are convenient for storing loose bulk items or left-overs. An alpha-numeric designation is assigned to each food bin 31, for example, “Carousel #1, Bin A.”

When a food item is to be stored in the refrigerator 11 or freezer 12, its bar code, if available, is scanned using the bar code scanner 29. If no bar code is available, the keypad 27 of the computer 17 is used to select from a menu of descriptions and to enter the quantity, e.g., “six apples.”

For each food item, after its bar code is scanned or its description/quantity entered, the computer 17 assigns a specific location for the item by an alpha-numeric designation of a carousel shelf 13 and a shelf segment 18 or a food bin 31, or by a side shelf 22. For example, a gallon of milk may be assigned to “Carousel #3, Segment C,” while a bunch of grapes is assigned to “Carousel #2, Bin B,” and a jar of olives to “Shelf #5.”

The computer 17 will assign locations to food items based on the optimal temperature for that item and also based on compatibility with other food items stored in close proximity. Where multiple temperature zones exist within the refrigerator 11 or freezer 12, the computer 17 may alter the thermostat settings for one or more zones to better comport with the optimal refrigeration temperature of the food items stored there.

To aid the user in locating the assigned storage location, the computer 17 will control the motors 16 to rotate the assigned carousel shelf 13 so that the assigned shelf segment 18 or food bin 31 is aligned with the central access door 26 of the refrigerator 11. As a further aid to the user, the LED marker lights 20 for an assigned shelf segment 18 will signal in some way, for example, by flashing on and off. There would be similar signaling of an assigned food bin 31 by the marker lights 20, and of an assigned side shelf 22 by the shelf lights 24.

Once the refrigerator 11 and freezer 12 are stocked, the computer 17 compiles an inventory of food items, including information on quantity, volume or weight, purchase date, and expiration date, if available. Where an expiration date is not included in the bar code or otherwise entered in the computer 17, the computer 17 will assign an expiration date based on the type of food item and the temperature in its assigned location. When a food item has reached or is approaching its expiration date, the computer 17 will provide a warning notice.

The compiled inventory of food items can be searchably displayed on the computer's display screen 28, such that touching or clicking on an inventory item will activate a retrieval operation, which will spin the assigned carousel 13 around to a position where the assigned segment 18 or bin 31 will be accessible from the central access door 26 of the refrigerator 11. The retrieval operation would also be accompanied by signaling of the appropriate LED marker lights 20 or shelf lights 24 for the location where the desired item is stored.

When a retrieved food item is replaced, the appropriate inventory item on the computer 17 is again touched or clicked to activate a replacement operation, which again spins the appropriate carousel 13 into alignment with the central access door of the refrigerator 11. If a retrieved item is not replaced within a certain time—an hour, for example—the computer 17 will delete the item from the inventory and add it to a “re-stock” list. The “re-stock” list becomes the basis for future grocery shopping lists. Optionally, the system computer can be wirelessly networked to a remote printer to enable printouts of the inventory and/or re-stock lists, or the computer 17 can be provided with internet access and programmed to periodically upload one or both of these lists to a website affording password-controlled access from a pc or mobile device. With internet access, the programming of the system computer 17 could also offer the option of periodic automated ordering of re-stock items from an online grocery service.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. An apparatus comprising a refrigerator or a freezer, or a combination refrigerator and freezer, and further comprising:
multiple circular carousel shelves, which are axially rotatable about one or more vertical spindle(s) by a motor;
multiple side shelves surrounding the peripheries of the carousel shelves;
one or more temperature zone(s), wherein the temperature within each temperature zone is controlled by a zone thermostat;
a system computer, which has one or more user interface(s) through one or more keypad(s), keyboard(s), touchscreens, or wireless connections, and which has one or more display screen(s);
wherein the system computer controls the motor and thereby controls the rotation of the carousel shelves; and
wherein the system computer controls each of the zone thermostats and thereby controls the temperature in each temperature zone.

2. The apparatus according to claim 1, further comprising:
one or more bar code readers, by means of which the bar codes of food items to be stored within the refrigerator or freezer are scanned, and wherein the system computer interfaces with and receives item data from each of the bar code readers, and wherein the system computer compiles and displays the item data in the form of one or more item lists.

3. The apparatus according to claim 2, wherein the item data for food items without bar codes are manually entered into the system computer through the user interface.

4. The apparatus according to claim 3, wherein the system computer, based upon the item data, assigns to each food item a storage location on one of the carousel shelves, or on one of the side shelves, and wherein, in assigning the storage location, the system computer takes into account the optimal storage temperature of the food item, its expiration date, and its compatibility with other food items stored in nearby storage locations.

5. The apparatus according to claim 4, wherein the item lists include an inventory, which lists all of the stored food items and includes item data, subject to availability, comprising item descriptions, quantities, volumes, weights, purchase dates and expiration dates.

6. The apparatus according to claim 5, wherein the inventory is interactive, such that, through the user interface, food items can be selected for retrieval from the assigned storage location or replacement to the assigned storage location.

7. The apparatus according to claim 6, wherein each of the carousel shelves is divided into multiple shelf segments, demarcated by one or more LED marker lights, and wherein each of the side shelves is illuminated by one or more LED shelf lights, and wherein each shelf segment and each side shelf constitutes a separate storage location.

8. The apparatus according to claim 7, wherein, when a food item is selected for retrieval or replacement, the system computer activates the motor to rotate one of the carousel shelves so that the shelf segment that is the assigned storage location of the food item is accessible from a transparent central access door within a main access door of the refrigerator or the freezer.

9. The apparatus according to claim 8, wherein the system computer controls the segment markers and the shelf lights, and wherein, when a food item is selected for retrieval or replacement, the system computer causes the marker lights or the shelf lights of the assigned storage location of the food item to signal the storage location.

10. The apparatus according to claim 9, wherein, in the absence of a bar-coded expiration date for a food item, the system computer will assign a default expiration date to the food item based on the type of food item and the temperature of its assigned location.

11. The apparatus according to claim 10, wherein, based on the bar-coded or default expiration date of a food item, the system computer will track the expiration date and display periodic warnings regarding the approach or passage of the expiration date.

12. The apparatus according to claim 11, wherein the item lists compiled by the system computer include a re-stock list, comprising food items that have been removed and not replaced and food items that have passed their expiration dates.

13. The apparatus according to claim 12, wherein the system computer has an internet connection and periodically uploads the inventory, re-stock list and other item lists to a website with password-controlled access from a remote computer or a mobile device.

14. The apparatus according to claim 13, wherein the system computer periodically orders food items listed on the re-stock list from one or more online grocery services.
